(19) United States
(12) Patent Application Publication
(10) Pub. No.: US 2026/0056731 A1
(43) Pub. Date: Feb. 26, 2026

(54) SYSTEMS AND METHODS FOR TRACING CODE CHANGES AND UNDERLYING LOGIC FOR CODE OPTIMIZATION

(71) Applicant: BANK OF AMERICA CORPORATION, CHARLOTTE, NC (US)

(72) Inventors: Archana Vivek Pai, Mumbai (IN); Venugopala Rao Randhi, Hyderabad (IN); Vijaya Kumar Vegulla, Hyderabad (IN); Rama Venkata Kavali, Frisco, TX (US); Vetrivel Kalimuthu, Hyderabad (IN)

(73) Assignee: BANK OF AMERICA CORPORATION, CHARLOTTE, NC (US)

(21) Appl. No.: 18/811,635

(22) Filed: Aug. 21, 2024

(51) Int. Cl. G06F 8/71; G06F 8/35; G06F 8/41

(52) U.S. Cl. CPC G06F 8/71; G06F 8/35; G06F 8/443

(57) ABSTRACT

Systems, computer program products, and methods are described herein for tracing code changes and underlying logic for code optimization. The present disclosure is configured to identify a code command(s) associated with an application; apply a large language model (LLM) to the code command(s); identify, by the LLM, code change(s) in the code command(s); identify, by the LLM and based on the code change(s), a logic module(s) for the code change(s); verify, by a generative artificial intelligence (AI) engine, a link between the logic module(s) and the code command(s) comprising the code change(s), wherein the link indicates a causation of the code change(s) with the logic module(s); and generate, by the generative AI engine and based on the verification of the link, the optimized code command(s) based on the code command(s) and the logic module(s).

### FIELD OF THE INVENTION

The present invention embraces a system for tracing code changes and underlying logic for code optimization.

### BACKGROUND

In network environments, issues often arise when code commands are recorded and inputs are used to generate new outputs regularly and in large batches, but where it can be difficult to determine the logic underlying each code command or code change. Further issues may arise where unexpected code changes are applied to the code commands and the logic needs to be determined efficiently, accurately, and dynamically. Additionally, and based on these code commands and code changes, in applications, logs, databases, and other such network components, optimizing the code commands and code changes efficiently and dynamically has become increasingly important in order to improve computing resource consumption, prevent duplicate code commands from being generated and used when unnecessary, and prevent non-optimized code commands from being used where optimized code commands are available.

Applicant has identified a number of deficiencies and problems associated with code commands, identifying code changes and logic underlying the code changes, and optimizing the code commands. Through applied effort, ingenuity, and innovation, many of these identified problems have been solved by developing solutions that are included in embodiments of the present disclosure, many examples of which are described in detail herein.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

A system for tracing code changes and underlying logic for code optimization is provided. In some embodiments, the system may comprise: a memory device with computer-readable program code stored thereon; at least one processing device operatively coupled to the at least one memory device and the at least one communication device, wherein executing the computer-readable code is configured to cause the at least one processing device to: identify at least one code command associated with an application; apply a large language model (LLM) to the at least one code command; identify, by the LLM, at least one code change in the at least one code command; identify, by the LLM and based on the at least one code change, at least one logic module for the at least one code change; verify, by a generative artificial intelligence (AI) engine, a link between the at least one logic module and the at least one code command comprising the at least one code change, wherein the link indicates a causation of the at least one code change with the at least one logic module; and generate, by the generative AI engine and based on the verification of the link, at least one optimized code command based on the at least one code command and the at least one logic module.

In some embodiments, the at least one optimized code command comprises at least one declare message, and wherein executing the computer-readable code is further configured to cause the at least one processing device to: transmit the at least one declare message to a log file associated with the at least one code command.

In some embodiments, a plurality of optimized code commands are generated by the generative AI engine, and wherein the plurality of optimized code commands comprise a plurality of declare messages, and wherein executing the computer-readable code is further configured to cause the at least one processing device to: generate a first collection of the plurality of declare messages; transmit the first collection of the plurality of declare messages to the log file associated with the at least one code command at a first instance; and write, in the log file, the first collection of the plurality of declare messages at a first instance.

In some embodiments, executing the computer-readable code is further configured to cause the at least one processing device to: identify at least one input table associated with the at least one code command, wherein the at least one input table comprises at least one input tuple variable; identify at least one output table based on applying the at least one code command comprising the at least one code change to the at least one input table, wherein the at least one output table comprises an unexpected output tuple variable; verify, by applying the at least one output table to the generative AI engine, the at least one logic module causing the at least one unexpected tuple variable; and generate, by the generative AI engine and based on the at least one unexpected tuple variable, a logic module message comprising an application identifier and logic module identifier associated with the verified at least one logic module. In some embodiments, the at least one input tuple variable and the at least one unexpected output tuple variable is associated with a same cell in the at least one input table and the at least one output table. In some embodiments, the logic module message comprises a combination of the application identifier and the logic module identifier, and wherein the logic module message comprises a time stamp or date stamp of the output table. In some embodiments, executing the computer-readable code is further configured to cause the at least one processing device to: generate a logic module table, wherein the logic module table comprises each of the logic modules verified by the generative AI engine for the application associated with the at least one code command, wherein the logic module table comprises a purpose column comprising a purpose description for each logic module in the logic module table.

In some embodiments, executing the computer-readable code is further configured to cause the at least one processing device to: test the at least one optimized code command based on the at least one logic module, wherein the test comprises a determination the at least one optimized code command is associated with less computing resources than the at least one code command; apply the determination of the test to a digital ledger agreement; and automatically trigger, by the digital ledger agreement and based on the determination the at least one optimized code commend comprises less computing resources than original computing resources of the at least one code command, a production of the at least one optimized code command to the application associated with the at least one code command.

In some embodiments, executing the computer-readable code is further configured to cause the at least one processing device to: test the at least one optimized code command based on the at least one logic module, wherein the test comprises a determination the at least one at least one logic module is associated with a plurality of optimized code commands associated with a plurality of applications, and wherein the determination comprises a primary optimized code command associated with a least amount of computing resources between the plurality of optimized code commands; apply the determination of the primary optimized code command to a digital ledger agreement; and automatically trigger, by the digital ledger agreement and based on the determination of the primary optimized code command, a production of the primary optimized code command to the plurality of applications.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for tracing code changes and underlying logic for code optimization, in accordance with an embodiment of the disclosure;

FIG. 2 illustrates an exemplary artificial intelligence (AI) engine subsystem architecture, in accordance with an embodiment of the disclosure;

FIGS. 3A-3B illustrate an exemplary distributed ledger technology (DLT) architecture, in accordance with an embodiment of the disclosure;

FIG. 4 illustrates a process flow for tracing code changes and underlying logic for code optimization, in accordance with an embodiment of the disclosure;

FIG. 5 illustrates a process flow for transmitting declare messages to a log file, in accordance with an embodiment of the disclosure;

FIG. 6 illustrates a process flow for writing a plurality of declare messages as a collection to a log file, in accordance with an embodiment of the disclosure;

FIG. 7 illustrates a process flow for generating a logic module table, in accordance with an embodiment of the disclosure;

FIG. 8 illustrates a process flow for automatically triggering a production of the optimized code command(s) to the application associated with the code command, in accordance with an embodiment of the disclosure;

FIG. 9 illustrates a process flow for automatically triggering the production of the primary optimized code command to a plurality of applications, in accordance with an embodiment of the disclosure;

FIG. 10 illustrates a process flow diagram for tracing code changes and underlying logic for code optimization, in accordance with an embodiment of the disclosure;

FIG. 11 illustrates exemplary code commands and declare messages for tracing code changes and underlying logic for code optimization, in accordance with an embodiment of the disclosure; and

FIG. 12 illustrates exemplary code commands and optimized code commands for tracing code changes and underlying logic for code optimization, in accordance with an embodiment of the disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In network environments, issues often arise when code commands are recorded and inputs are used to generate new outputs regularly and in large batches, but where it can be difficult to determine the logic underlying each code command or code change. Further issues may arise where unexpected code changes are applied to the code commands and the logic needs to be determined efficiently, accurately, and dynamically. Additionally, and based on these code commands and code changes, in applications, logs, databases, and other such network components, optimizing the code commands and code changes efficiently and dynamically has become increasingly important in order to improve computing resource consumption, prevent duplicate code commands from being generated and used when unnecessary, prevent non-optimized code commands from being used where optimized code commands are available, and improve tracing of unexpected outputs from the code commands and code changes with their underlying logic.

Accordingly, the present disclosure provides for the identification of code command(s) associated with an application; the application of a large language model (LLM) to the code command(s); the identification, by the LLM, of code change(s) in the code command(s); and the identification, by the LLM and based on the code change(s), of a logic module(s) for the code change(s). Further, the disclosure provides for the the verification, by a generative artificial intelligence (AI) engine, of a link between the logic module(s) and the code command(s) comprising the code change(s), wherein the link indicates a causation of the code change(s) with the logic module(s); and the generation, by the generative AI engine and based on the verification of the link, of the optimized code command(s) based on the code command(s) and the logic module(s).

In other words, the disclosure provides a system to autonomously trace logic behind code changes based on analyzing historical code changes using a large language model (LLM), which may be configured to match the historical code changes with logic modules (such as business logic modules), and then using a generative AI engine to generate optimized script commands that output the same code changes from the logic modules. Further, and by using the generative AI engine to generate optimized script commands to generate the code changes, the system may be used to accurately and granularly determine which command line has changed which output, and what the intended purpose was behind the code change. Based on these features, the invention may employ writing in the script files for the code changes using the gen AI component, which may reduce redundant script commands and code changes and prevent errors in code outputs and locks due to misunderstandings in code outputs.

What is more, the present invention provides a technical solution to a technical problem. As described herein, the technical problem includes code commands, identifying code changes and logic underlying the code changes, and optimizing the code commands. The technical solution presented herein allows for the accurate, efficient, and dynamic systems and methods for tracing code changes and underlying logic for code optimization. In particular, the disclosure is an improvement over existing solutions to code optimization and logic tracing (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

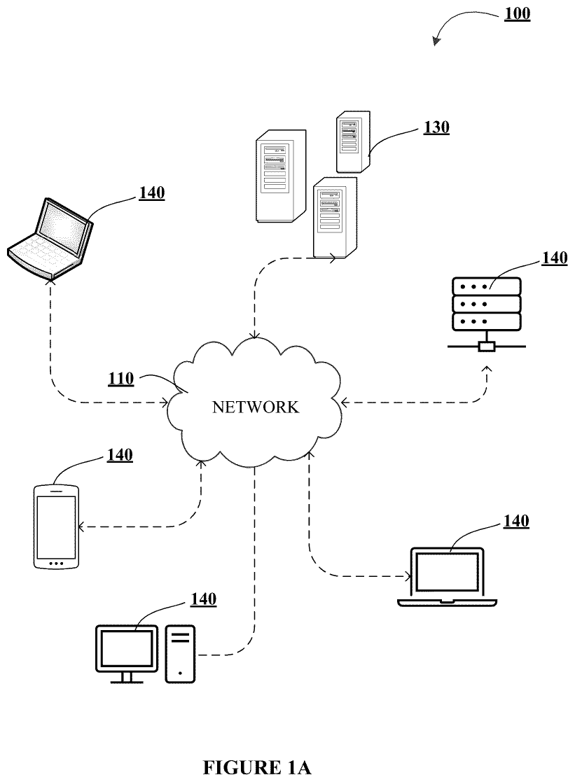

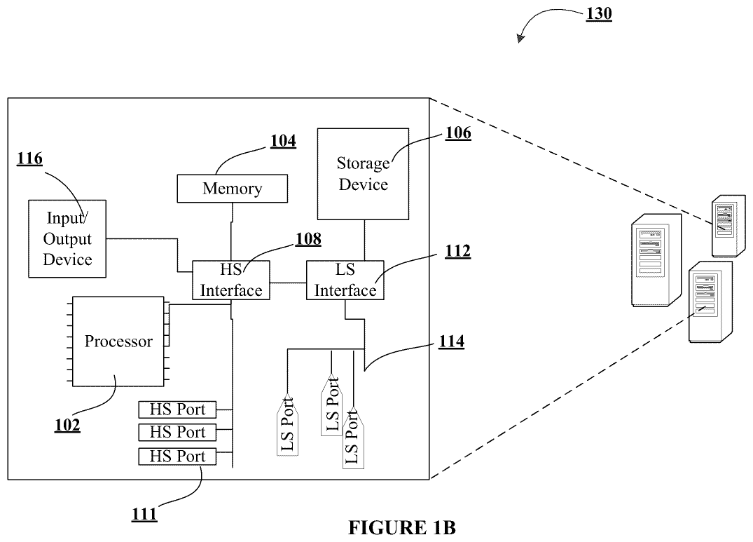

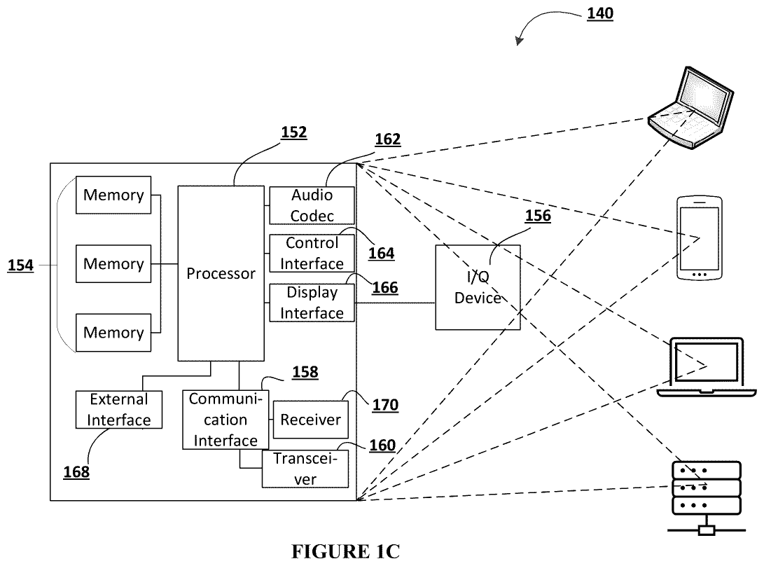

FIGS. 1A-1C illustrate technical components of an exemplary distributed computing environment for tracing code changes and underlying logic for code optimization 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low speed bus 114 (shown as “LS Port”) and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

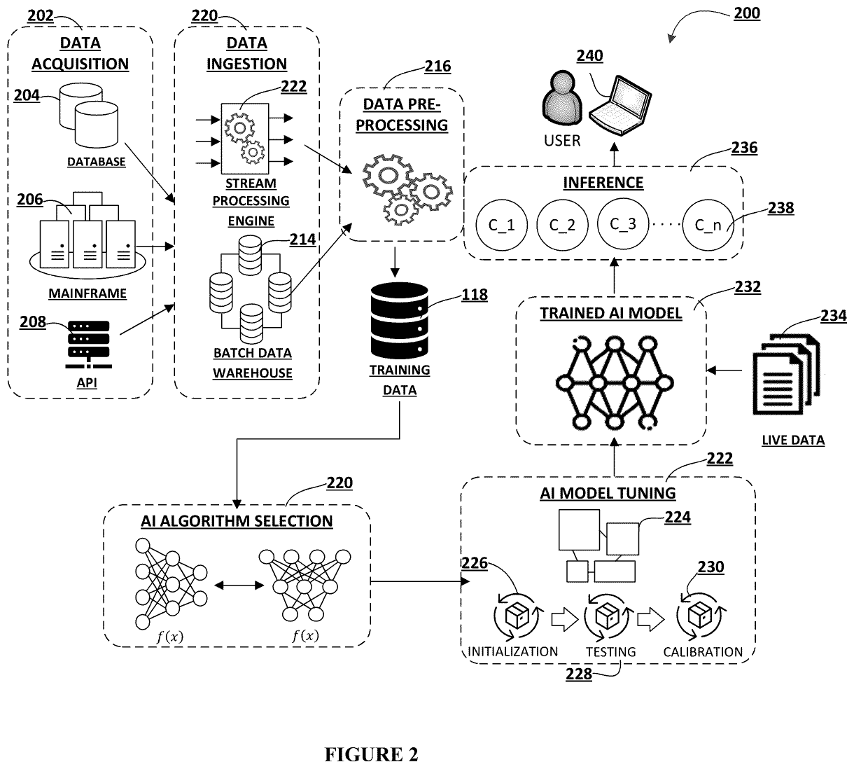

FIG. 2 illustrates an exemplary artificial intelligence (AI) engine subsystem architecture 200, in accordance with an embodiment of the disclosure. The artificial intelligence subsystem 200 may include a data acquisition engine 202, data ingestion engine 210, data pre-processing engine 216, AI engine tuning engine 222, and inference engine 236.

The data acquisition engine 202 may identify various internal and/or external data sources to generate, test, and/or integrate new features for training the artificial intelligence engine 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the artificial intelligence engine 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so a artificial intelligence engine can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI tuning engine 222 may be used to train an artificial intelligence engine 224 using the training data 218 to make predictions or decisions without explicitly being programmed to do so. The artificial intelligence engine 224 represents what was learned by the selected artificial intelligence algorithm 220 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable artificial intelligence engine type. Each of these types of artificial intelligence algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the artificial intelligence engine, the AI tuning engine 222 may repeatedly execute cycles of experimentation 226, testing 228, and tuning 230 to optimize the performance of the artificial intelligence algorithm 220 and refine the results in preparation for deployment of those results for consumption or decision making. To this end, the AI tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the engine is the measurement used to determine which set of hyperparameters is best at identifying relationships and patterns between variables in a dataset based on the input, or training data 218. A fully trained artificial intelligence engine 232 is one whose hyperparameters are tuned and engine accuracy maximized.

The trained artificial intelligence engine 232, similar to any other software application output, can be persisted to storage, file, memory, or application, or looped back into the processing component to be reprocessed. More often, the trained artificial intelligence engine 232 is deployed into an existing production environment to make practical business decisions based on live data 234. To this end, the artificial intelligence subsystem 200 uses the inference engine 236 to make such decisions. The type of decision-making may depend upon the type of artificial intelligence algorithm used. For example, artificial intelligence engines trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence engines trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, artificial intelligence engines that perform regression techniques may use live data 234 to predict or forecast continuous outcomes.

It will be understood that the embodiment of the artificial intelligence subsystem 200 illustrated in FIG. 2 is exemplary and that other embodiments may vary. As another example, in some embodiments, the artificial intelligence subsystem 200 may include more, fewer, or different components.

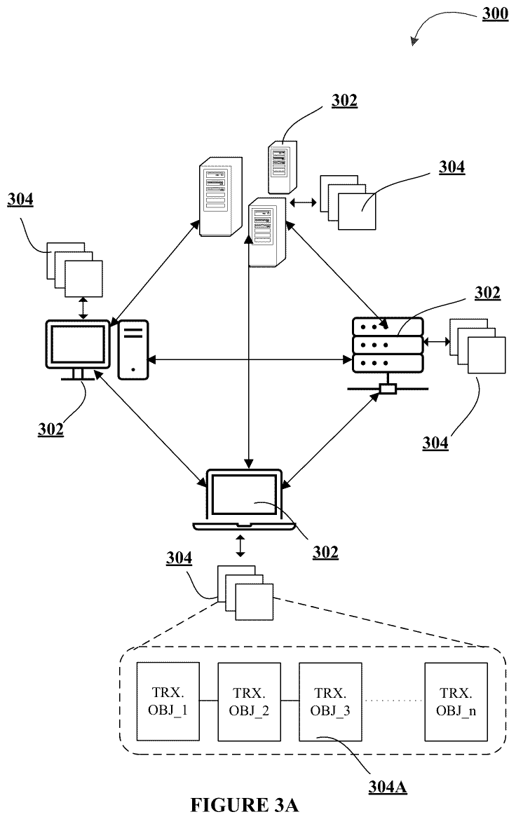

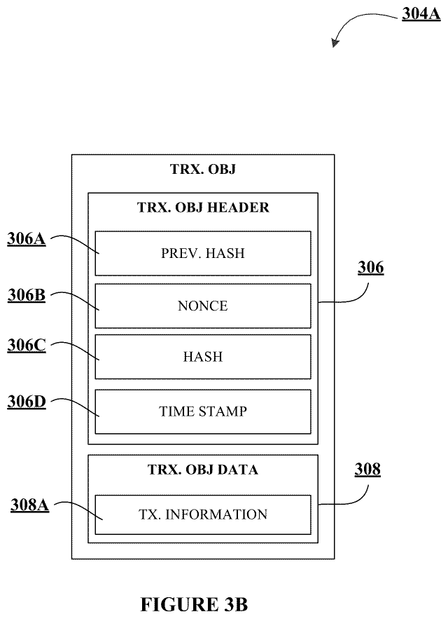

FIGS. 3A-3B illustrate an exemplary distributed ledger technology (DLT) architecture, in accordance with an embodiment of the disclosure. DLT may refer to the protocols and supporting infrastructure that allow computing devices (peers) in different locations to propose and validate transactions and update records in a synchronized way across a network. Accordingly, DLT is based on a decentralized model, in which these peers collaborate and build trust over the network. To this end, DLT involves the use of potentially peer-to-peer protocol for a cryptographically secured distributed ledger of transactions represented as transaction objects that are linked. As transaction objects each contain information about the transaction object previous to it, they are linked with each additional transaction object, reinforcing the ones before it. Therefore, distributed ledgers are resistant to modification of their data because once recorded, the data in any given transaction object cannot be altered retroactively without altering all subsequent transaction objects.

To permit transactions and agreements to be carried out among various peers without the need for a central authority or external enforcement mechanism, DLT uses smart contracts. Smart contracts are computer code that automatically executes all or parts of an agreement and is stored on a DLT platform. The code can either be the sole manifestation of the agreement between the parties or might complement a traditional text-based contract and execute certain provisions, such as transferring funds from Party A to Party B. The code itself is replicated across multiple nodes (peers) and, therefore, benefits from the security, permanence, and immutability that a distributed ledger offers. That replication also means that as each new transaction object is added to the distributed ledger, the code is, in effect, executed. If the parties have indicated, by initiating a transaction, that certain parameters have been met, the code will execute the step triggered by those parameters. If no such transaction has been initiated, the code will not take any steps.

Various other specific-purpose implementations of distributed ledgers have been developed. These include distributed domain name management, decentralized crowd-funding, synchronous/asynchronous communication, decentralized real-time ride sharing and even a general purpose deployment of decentralized applications. In some embodiments, a distributed ledger may be characterized as a public distributed ledger, a consortium distributed ledger, or a private distributed ledger. A public distributed ledger is a distributed ledger that anyone in the world can read, anyone in the world can send transactions to and expect to see them included if they are valid, and anyone in the world can participate in the consensus process for determining which transaction objects get added to the distributed ledger and what the current state each transaction object is. A public distributed ledger is generally considered to be fully decentralized. On the other hand, fully private distributed ledger is a distributed ledger whereby permissions are kept centralized with one entity. The permissions may be public or restricted to an arbitrary extent. And lastly, a consortium distributed ledger is a distributed ledger where the consensus process is controlled by a pre-selected set of nodes; for example, a distributed ledger may be associated with a number of member institutions (say 15), each of which operate in such a way that the at least 10 members must sign every transaction object in order for the transaction object to be valid. The right to read such a distributed ledger may be public or restricted to the participants. These distributed ledgers may be considered partially decentralized.

As shown in FIG. 3A, the exemplary DLT architecture 300 includes a distributed ledger 304 being maintained on multiple devices (nodes) 302 that are authorized to keep track of the distributed ledger 304. For example, these nodes 302 may be computing devices such as system 130 and client device(s) 140. One node 302 in the DLT architecture 300 may have a complete or partial copy of the entire distributed ledger 304 or set of transactions and/or transaction objects 304A on the distributed ledger 304. Transactions are initiated at a node and communicated to the various nodes in the DLT architecture. Any of the nodes can validate a transaction, record the transaction to its copy of the distributed ledger, and/or broadcast the transaction, its validation (in the form of a transaction object) and/or other data to other nodes.

As shown in FIG. 3B, an exemplary transaction object 304A may include a transaction header 306 and a transaction object data 308. The transaction header 306 may include a cryptographic hash of the previous transaction object 306A, a nonce 306B—a randomly generated 32-bit whole number when the transaction object is created, cryptographic hash of the current transaction object 306C wedded to the nonce 306B, and a time stamp 306D. The transaction object data 308 may include transaction information 308A being recorded. Once the transaction object 304A is generated, the transaction information 308A is considered signed and forever tied to its nonce 306B and hash 306C. Once generated, the transaction object 304A is then deployed on the distributed ledger 304. At this time, a distributed ledger address is generated for the transaction object 304A, i.e., an indication of where it is located on the distributed ledger 304 and captured for recording purposes. Once deployed, the transaction information 308A is considered recorded in the distributed ledger 304.

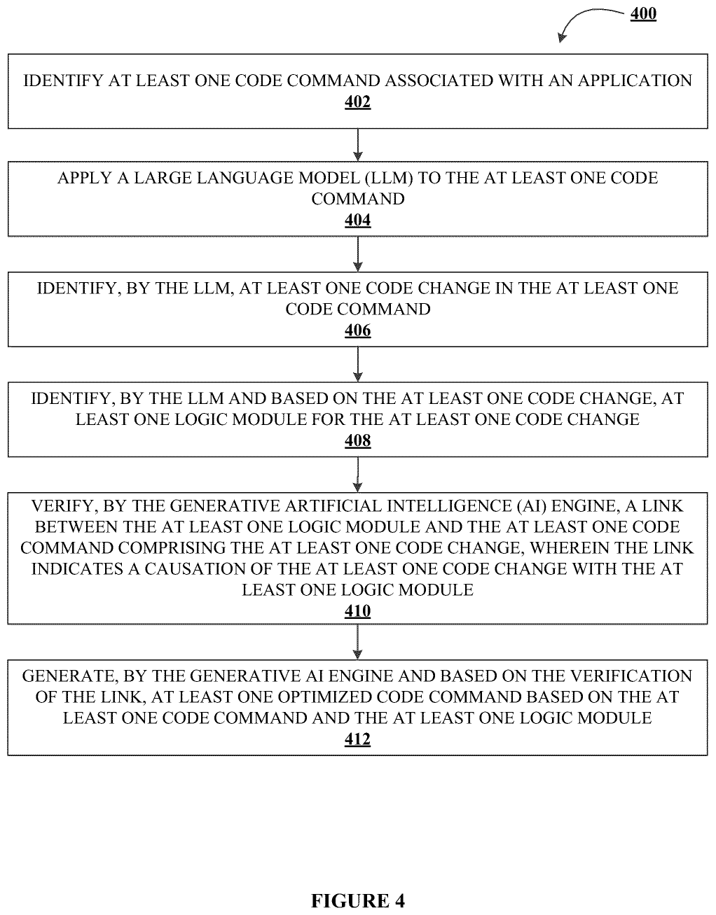

FIG. 4 illustrates a process flow 400 for tracing code changes and underlying logic for code optimization, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400. In some embodiments, an artificial intelligence engine (e.g., such as the AI engine shown in FIG. 2) may perform some or all of the steps described in process flow 400. In some embodiments, a distributed ledger technology (e.g., the DLT shown in FIGS. 3A-3B) may be used to perform some or all of the steps described in process flow 400.

As shown in block 402, the process flow 400 may include the step of identifying at least one code command associated with an application. For example, such a code command may comprise a script file's piece of code, script file's command, line within a script file, a plurality of script lines that take an input and generate an output, a file, and/or the like. Thus, and as used herein, the code command refers to an instruction written in computer readable programming language for the computer or its processors/servers to perform a specific task (such as transforming an input of data to an output of data based on the instruction(s)). Further, and as used herein, the code command(s) may be associated with an application, such as an software application designed to perform a specific function(s) within a system/computing environment. In some embodiments, the application described herein may comprise, but is not limited to, an interface application, a business application, a database, a multimedia application, an open source application, a closed source application, a project management application, and other such software applications. Thus, and in some embodiments, the code command(s) associated with an application may refer to the code command(s) stored within an application associated with a computing system or device that is communication with the system described herein (e.g., operatively coupled to the system described herein, communicating over a network with the system described herein, and/or the like). Thus, and in such embodiments, the application may comprise, manage, store, and/or generate any of the code commands described herein.

In some embodiments, the system may identify the code command(s) by identifying an immediate previous version (to the current version) of the code command(s). Such a previous version of the code command may be identified based on the system receiving a trigger that the code command has been updated. In some embodiments, the system may identify the code command based on identifying an unexpected output from the previous code command's output (such as an unexpected output variable or tuple variable in the output table as compared to the previous version of the output table). Such an unexpected output may be flagged by the system and may indicate that the underlying code command has changed (e.g., the instructions within the code command has changed) and/or that a manual input or intervention has been input into the output of the code command (output table of the code command).

As shown in block 404, the process flow 400 may include the step of applying a large language model (LLM) to the at least one code command. For instance, and as described herein, a large language model (LLM) may be designed, trained, and configured to analyze and understand the text within the code command, the code command's intended functionality, and how the code command works. The LLM described herein may be trained on large amounts of code command data, code change data (i.e., amendments or changes within the code commands), logic module data, input data for historical code commands, output data of historical code commands, and/or the like. In this manner, the LLM may be pre-trained on historical code commands, historical code changes, historical logic modules, historical input and output data for the historical code commands, and/or the like. Such a training on the base code commands, their code changes, the underlying logic modules for the code changes, and the effect on the output data from the input data based on the code changes may allow the LLM to dynamically and accurately determine changes to the current code commands between previous versions of the code commands and current version of the code commands, determine changes in the output table(s) from previous versions to the current versions, any changes to the code command file and/or any changes to the input tables and/or output tables, and/or the like.

As used herein, the system may apply the LLM to the code command by inputting the code command to the LLM, such that the LLM may process and analyze the code command and determine the changes from previous versions to the current version of the code command. Such an input of the code command to the LLM may comprise an input of the previous versions of input and output data, the current version of input and output data, and/or the like. In some embodiments, the input of the code command may further comprise an input of the potential logic modules that could be chosen from or match to for the current code command as the underlying logic behind the instructions of the code command.

As shown in block 406, the process flow 400 may include the step of identifying, by the LLM, at least one code change in the at least one code command. For example, the LLM may process each line within the code command, which may further comprise analyzing the input and output of the code command, the previous version of the code command (and in some embodiments, the previous version's input and output), and/or the like. For instance, the system may identify—using the LLM—at least one code change in the code command by analyzing the similarities and differences between the previous version(s) of the code command and the current code command. Additionally, and/or alternatively, the LLM may identify the at least one code change in the code command by analyzing the similarities and differences between the previous version of the code command's input and output data, and the current code command's input and output data. In some embodiments, the LLM may further determine the specific code change(s) within the code command(s) by analyzing individual lines of code within the code command, as well as the surrounding lines (e.g., immediately surrounding lines of code) of the changed individual line(s) of code. In this manner, the LLM may analyze the context around the changed lines of code to create a fuller picture of the overall change within the code command and its overall effect on the code command. Thus, and in some embodiments, the code changes may be limited to only one line of code, a plurality of lines of code (such as a plurality of lines of code that take in an input, process the input, and generate an output based on the input), and/or the like.

As shown in block 408, the process flow 400 may include the step of identifying, by the LLM and based on the at least one code change, at least one logic module for the at least one code change. For instance, the system may identify—using the LLM and based on the identified code change(s)—at least one logic module that matches the underlying reason or intent behind the code command with the code change. In some embodiments, and where no code changes have been identified in a current version of the code command, the system may still use the LLM to identify the logic module associated with the unchanged code command. In this manner, and when a file comprising the code command with the code change is being analyzed and a logic module is being identified for the code command with the code change, the system may further identify the logic module(s) for the other code command(s) within the same file, which may allow for an overall picture of the underlying logics used for the file.

As used herein, the logic module refers to the underlying logic or intent behind the code command with the code change, whereby the LLM-determined intent or underlying logic of the code command with the code change may be linked or associated with a potential logic module. In some such embodiments, the potential logic modules for the LLM to select from and match to the underlying logic of the code command(s) may be stored in a logic module database, whereby the logic module database may be analyzed by the system using the LLM. In some embodiments, the underlying logic of the code command may be separated into attributes generated by the LLM, and such attributes may be used to match to the attributes of the logic modules within the logic module database for more accurate matching between the current code command and the logic modules within the logic module database.

In some embodiments, and as described herein, the term “logic module” may refer to a rule within an entity associated with the application, such as a business rule, a data security rule, an algorithmic rule, a data validation rule, an organizational rule, and/or the like. Thus, and where a code command (with and/or without the code change) is analyzed to determine the logic module, the system may determine the rule intended behind the generation of the code command.

As shown in block 410, the process flow 400 may include the step of verifying, by the generative artificial intelligence (AI) engine, a link between the at least one logic module and the at least one code command comprising the at least one code change, wherein the link indicates a causation of the at least one code change with the at least one logic module. For example, the system may—using a pre-trained generative AI engine—to verify the identified logic module for the code command with (or without) the code change, such that an extra layer of accuracy may be added to the logic module determination. In this manner, the pre-trained generative AI engine may be trained on historical code commands, historical code changes, historical logic modules, and/or the like, to determine whether the identified logic module by the LLM is the correct logic module to choose for the code command. In some embodiments, and where the generative AI engine determines that the LLM is incorrect in its identification of the logic module for the code command, the generative AI engine may be configured to come up with its own underlying intent and logic module for the code command which more accurately matches the code command at issue. In contrast, and in such embodiments where the LLM was correct in its determination of the logic module, the generative AI engine may verify the logic module as the correct logic module for the code command. Further, and as described herein, the generative AI engine may be based on the AI engine shown and described above with respect to FIG. 2.

Thus, and as used herein, the verification of the link between the logic module and the code command refers to the verification of the association or relationship between the logic module and the code command. Therefore, such a generative AI engine may be trained and configured to generate the associations, relationships, and/or links between the code command with the code change and the determined logic module, whereby the link may indicate that the logic module caused the code change within the code command (where the code command comprises the code change and the logic module matches intent behind the code change) and/or the logic module caused the code command (where the code command does not comprise a code change). In some embodiments, and where two logic modules are used to describe the code command and the change code, the system—using the generative AI engine—may combine the two logic modules to create a new logic module describing the overall intent and functionality of the code command with the code change.

As shown in block 412, the process flow 400 may include the step of generating, by the generative AI engine and based on the verification of the link, at least one optimized code command based on the at least one code command and the at least one logic module. For instance, the system may use a generative AI engine, such as a generative AI bot, to generate an optimized version of the code command (with and/or without the code change) which may be referred to as an optimized code command. Thus, and in some such embodiments, the optimized code command may comprise a generated code command by the generative AI engine based on both the underlying intent of the logic module and the code command (with or without the code change, where applicable), whereby the generated code comprises declare messages indicating the logic module(s) for each code command in a simple and streamlined format (e.g., as a command line which may be used for writing to a log file associated with the application of the code command) and the details of the optimized code command (e.g., the input and output of the optimized code command, the current state of the optimized code command, and/or the like). Further, and in such embodiments, the generated code may comprise less log file write commands than the original file or previous versions of the file with the non-generated code commands (e.g., the log file write commands may wait until a certain number of declare messages have been generated instead of writing to the log file after every declare message has been generated like the original file may have done). Additionally, and in some embodiments, the optimized code command may further comprise optimized code lines which are streamlined and lessened in their character length, such that the processing speed of the system processing each line of the code command can be quickened and improved.

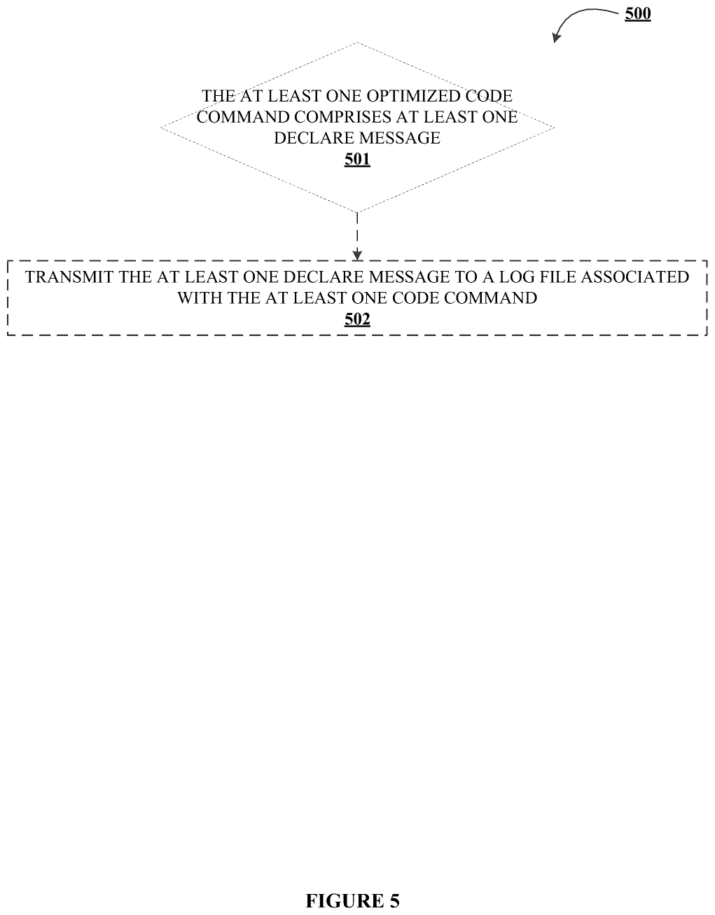

FIG. 5 illustrates a process flow 500 for transmitting declare messages to a log file, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process 500. In some embodiments, an artificial intelligence engine (e.g., such as the AI engine shown in FIG. 2) may perform some or all of the steps described in process flow 500. In some embodiments, a distributed ledger technology (e.g., the DLT shown in FIGS. 3A-3B) may be used to perform some or all of the steps described in process flow 500.

In some embodiments, and as shown in block 501, the process flow 500 may include the step of determining the at least one optimized code command comprises at least one declare message. For example, and in some such embodiments, the system may determine the at least one optimized code command comprises a declare message by determining that the system generated the declare message during the generation of the optimized code command. In some embodiments, and where the original code command comprised its own declare message (such as a declare command within a line of the original code command), the system may recycle a portion or all of the declare command for the optimized code command. In such embodiments, the system—using the generative AI engine—may place the original declare message(s) (and/or a portion of the original declare message(s)) in the optimized code command in a different line of the optimized code command than the original line in the original code command (e.g., place the declare message of the optimized code command closer to other declare messages such that the declare messages may be generated and collected at a quicker speed when processing each line of optimized code command). Additionally, and as used herein, the term “declare message” refers to a message generated to show the overall intent behind the code command and the logic module (e.g., the code command based on the overall code command with or without the change code, whereby the declare message may be updated based on the change code and the logic module). Further, such a declare message may be intended to be written to a log file associated with the application that is associated with the code command. For example, such a log file may refer to the software-generated files that record information about the application's activities, code commands, inputs and outputs, operations, usage patterns, and/or the like.

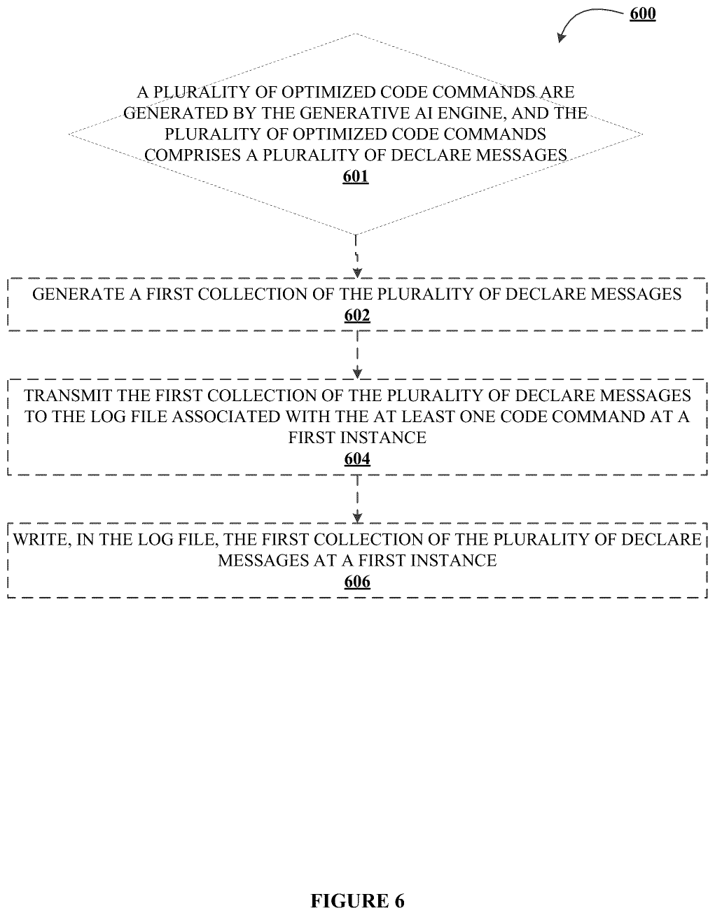

In some embodiments, and as shown in block 502, the process flow 500 may include the step of transmitting the at least one declare message to a log file associated with the at least one code command. Such a declare message generated by the system may be transmitted to the log file of the application over a network, or by operatively coupling the system with the application, such that the declare message(s) may be generated and collected, and then transmitted at a pre-defined time or pre-defined collection rate. For example, the system may be configured to only send the declare messages to the log file after three declare messages have been generated (e.g., as a file is running each input, line by line, a declare message may be generated for each code command portion). In some embodiments, the declare message threshold (i.e., the number of declare messages that must be generated and collected before transmission to the log file) may be pre-determined by a client of the system, by a manager of the system, by the system itself based on past or historical declare message thresholds and based on historical computer processing performance and/or network performance (e.g., transmissions within the network may be lessened by collecting more declare messages and waiting to send the declare messages in larger batches), and/or the like. Such an embodiment is described in more detail hereinbelow with respect to FIG. 6.

In some embodiments, the declare message threshold may comprise a time threshold, whereby the time threshold may indicate a maximum amount of time between declare messages being generated and collected and the next transmission to the log file. For example, and in such embodiments, the system may be configured to send the declare message(s) every minute if the declare message threshold has not been met after a latest declare message was generated, collected, and not transmitted (e.g., the declare message is waiting longer than a minute for another declare message to be generated, collected, and transmitted).

FIG. 6 illustrates a process flow 600 for writing a plurality of declare messages as a collection to a log file, in accordance with an embodiment of the disclosure. In some embodiments, a system (e.g., similar to one or more of the systems described herein with respect to FIGS. 1A-1C) may perform one or more of the steps of process flow 600. For example, a system (e.g., the system 130 described herein with respect to FIG. 1A-1C) may perform the steps of process 600. In some embodiments, an artificial intelligence engine (e.g., such as the AI engine shown in FIG. 2) may perform some or all of the steps described in process flow 600. In some embodiments, a distributed ledger technology (e.g., the DLT shown in FIGS. 3A-3B) may be used to perform some or all of the steps described in process flow 600.

In some embodiments, and as shown in block 601, the process flow 600 may include the step of determining a plurality of optimized code commands are generated by the generative AI engine, and the plurality of optimized code commands comprises a plurality of declare messages. In some embodiments, the system may determine that the plurality of optimized code commands was generated by the generative AI engine based on the generation of the optimized code commands at the generative AI engine, whereby the determination may be based on receiving a trigger from the system (e.g., the generative AI engine) that the optimized code command(s) have been generated. In some embodiments, the system may determine the optimized code command(s) has been generated by the generative AI engine based on identifying that the generative AI engine has generated an output, here an optimized code command.

In some embodiments, each of these optimized code commands may comprise at least one declare message, whereby each declare message may indicate the details of the optimized code command. In some such embodiments, a file comprising a plurality of optimized code commands may comprise a plurality of declare messages, whereby each optimized code command has its own declare message.

In some embodiments, and as shown in block 602, the process flow 600 may include the step of generating a first collection of the plurality of declare messages. For example, and in some such embodiments, the system may generate at least a first collection of the plurality of declare messages by collecting the plurality of declare messages in a first batch. In some such embodiments, the first collection of declare messages may be based on at least one of the declare message threshold and/or the time threshold described hereinabove. Further, and as mentioned above, the declare message threshold and the time threshold may be configurable by a client of the system, by a manager of the system, by the system itself, and/or the like. Such a configuration of the declare message threshold and/or the time threshold may be input to a user device associated with the client of the system, and/or the manager of the system, and such an input may be transmitted from the user device to the system via a network (e.g., the network shown and described with respect to FIGS. 1A-1C).

Further, and in some such embodiments, the first collection of the plurality of declare messages may be collected as the declare messages are generated in the optimized code commands that are run. As the declare messages are generated, the system may actively identify each declare message as it is generated and output from the optimized code command, and actively collect each declare message in series as each declare message is generated (such that the sequence of generation is kept in the collection).

Additionally, and as understood by a person of skill in the art, the description of the first collection of declare messages is not meant to be limiting, but instead is meant to show that how a collection of declare messages may be generated. Further embodiments may comprise additional and later collections declare messages as the declare message threshold and/or the time threshold is met for each declare message for an application and its log file.

In some embodiments, and as shown in block 604, the process flow 600 may include the step of transmitting the first collection of the plurality of declare messages to the log file associated with the at least one code command at a first instance. For example, and in some such embodiments, the system may transmit—from the system to the log file associated with the application—at least the first collection of the declare messages. Further, and as understood by a person of skill in the art, and as declare messages are generated on a continuous basis as the optimized code commands are run, future collections beyond this first collection may be generated and transmitted to the log file. Thus, the description of the transmission of this first collection at a first instance is not intended to be limiting, but instead meant to show the process of collecting and transmitting each collection of declare messages as they are generated at later instances.

Further, and as shown herein, such a collection of declare messages and transmission of the declare messages allows for less network transmissions between the system and the log file as a collection of multiple declare messages are transmitted at a time, rather than continuous and individual transmissions each time a declare message is generated.

In some embodiments, and as shown in block 606, the process flow 600 may include the step of writing, in the log file, the first collection of the plurality of declare messages at a first instance. For instance, and in some such embodiments, the system may trigger an automatic writing within the log file of each of the declare messages within the collection (e.g., the first collection and/or any subsequent or later collections), whereby the log file may record each declare message as they are received within the collection such that the log file can keep an accurate and up-to-date record of the optimized code commands and their details (e.g., current inputs, outputs, logic modules, other such data described herein, and/or the like).

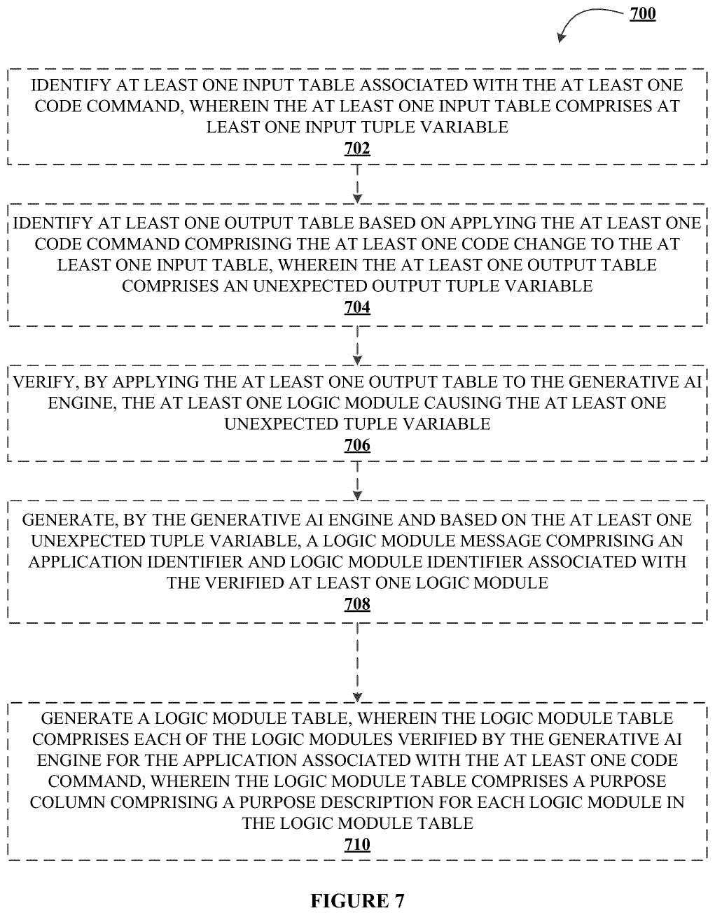

FIG. 7 illustrates a process flow 700 for generating a logic module table, in accordance with an embodiment of the disclosure. In some embodiments, a system (e.g., similar to one or more of the systems described herein with respect to FIGS. 1A-1C) may perform one or more of the steps of process flow 700. For example, a system (e.g., the system 130 described herein with respect to FIG. 1A-1C) may perform the steps of process 700. In some embodiments, an artificial intelligence engine (e.g., such as the AI engine shown in FIG. 2) may perform some or all of the steps described in process flow 700. In some embodiments, a distributed ledger technology (e.g., the DLT shown in FIGS. 3A-3B) may be used to perform some or all of the steps described in process flow 700.

In some embodiments, and as shown in block 702, the process flow 700 may include the step of identifying at least one input table associated with the at least one code command, wherein the at least one input table comprises at least one input tuple variable. For example, and in some such embodiments, the system may identify at least one input table applied to the at least one code command(s) and/or the optimized code command(s), such that the code command(s) and/or the optimized code command(s) processes the input(s) of the input table and generate an output(s). As used in this explanation of FIG. 7, the use of the code command(s) and/or the optimized code command(s) for processing the input table, generating the output table, and/or the like, may be used depending on which code command (e.g., the original code command and/or the optimized code command) that is to be tested based on the output table generated. For example, and where the optimized code generates an unexpected tuple variable(s) based on the application of the input table to the optimized code command, the system may need to determine an updated logic module for the optimized code command as the optimized code command may have been updated and/or changed to create the unexpected output tuple variable.

In some embodiments, the input table may comprise a plurality of input data variables, such as an input tuple variable (i.e., a record of data within the input table), which may be applied to the code command(s) and/or the optimized code command(s), which in turn generate an output tuple variable based on the instructions and commands within the code command(s) and/or the optimized code command(s). Further, and in some embodiments, such as those described above, the code command may comprise at least one code change that could cause the application of the input tuple variable to generate an unexpected output tuple variable. Such an embodiment is further disclosed hereinbelow.

Additionally, and in some such embodiments, the system may identify such an input table and its associated input variables based on receiving the input table from the application associated with the code command; based on receiving the input table from a client of the system, from a manager of the system, and/or the like; based on collecting input data from various systems and/or networks which may generate the input table and transmit the input table to the system for verification with the code command(s); and/or the like.

In some embodiments, and as shown in block 704, the process flow 700 may include the step of identifying at least one output table based on applying the at least one code command comprising the at least one code change to the at least one input table, wherein the at least one output table comprises an unexpected output tuple variable. For instance, and in some embodiments, the system may identify an output table generated by the code command(s) (with and/or without the code change(s)) and/or optimized code command(s), whereby the output table is generated based on applying the input table of input variables to the code command(s) and/or optimized code command(s). Such an unexpected output tuple variable refers to a record of data that is unexpected based on the input data applied to the code command(s) and/or the optimized code command(s), which may indicate that an unexpected code change has occurred within the code command(s) and/or the optimized code command(s), and/or that the output table has been manually intervened with a user input for the unexpected output tuple variable. Additionally, and as used herein, the output table may comprise expected output tuple variable(s) which are expected based on the input data applied to the code command(s) and/or the optimized code command(s).

Further, and in some such embodiments, the at least one input tuple variable and the at least one unexpected output tuple variable may be associated with a same cell in the at least one input table and the at least one output table. For instance, and in such embodiments, an input table and the generated output table may comprise the same number of rows and columns, such that the same number and position of cells are shared between the input table and output table. Thus, and in such embodiments, an input tuple variable may share the same cell or position within the input table as the expected or unexpected output tuple variable. In some embodiments, the cell or position within the input and output table may refer to the same portion of the code command that the input was applied to and that generated the output.

In some embodiments, and as shown in block 706, the process flow 700 may include the step of verifying, by applying the at least one output table to the generative AI engine, the at least one logic module causing the at least one unexpected tuple variable. For instance, and in some such embodiments, the system may verify—based on applying the output table and its tuple variables (expected and/or unexpected variable(s)) to the generative AI engine—a logic module for the current code command(s) and/or the current optimized code command(s) that generated the output table. Similar to the description provided above with respect to FIG. 4, the generative AI engine may function in a similar manner to determine the logic module for the current code command(s) and/or the current optimized code command(s) based on the input table and the output table, the code command(s), the code change(s) (where applicable), and/or the like. Thus, and in some such embodiments, the generative AI engine may determine the logic module that could have caused the unexpected output tuple variable(s).

In some embodiments, and as shown in block 708, the process flow 700 may include the step of generating, by the generative AI engine and based on the at least one unexpected tuple variable, a logic module message comprising an application identifier and logic module identifier associated with the verified at least one logic module. For instance, and in some such embodiments, the system may generate—using the generative AI engine—a logic module message comprising the intent and/or reasoning behind the unexpected output tuple variable. In some embodiments, the logic module message may further comprise a brief description of the logic behind the unexpected output tuple variable, an application identifier for the associated application of the code command, the logic module identifier (e.g., which may be based on the type of rule within the entity that the logic module is based on, the storage location of the rule, and/or the like), a timestamp of the generation for the output table and/or tuple variable(s), and/or the like. Further, and in some such embodiments, the system—using the generative AI engine—may verify the logic module determined for the code command(s) and/or optimized code command(s) based the same process described hereinabove with respect to FIG. 4.

Additionally, and in some such embodiments, such a logic module message may be shown in an extra column of the output table, such that the reasoning behind the each of the variables within the output table is shown and described using the logic module. In some embodiments, the logic module message may be expanded to create a logic module global table for the file comprising the code command(s), whereby the logic module global table may comprise a column for the application identifier, a column for the logic module identifier, a purpose column with a short description of the underlying purpose behind the logic module and its effect on the code command, and/or the like.

In some embodiments, and as shown in block 710, the process flow 700 may include the step of generating a logic module table, wherein the logic module table comprises each of the logic modules verified by the generative AI engine for the application associated with the at least one code command, wherein the logic module table comprises a purpose column comprising a purpose description for each logic module in the logic module table. For instance, and in some such embodiments, the system may generate a logic module table comprising each of the logic modules verified by the generative AI engine for each of the outputs generated by the code command(s), whereby the logic module table may easily show and describe each of the outputs generated by the code command(s) and the underlying logic for each output. Further, and in some such embodiments, the logic module table may comprise the logic module message described hereinabove. Thus, and in some embodiments, the logic module message comprises a combination of the application identifier and the logic module identifier, and wherein the logic module message comprises a time stamp or date stamp of the output table.

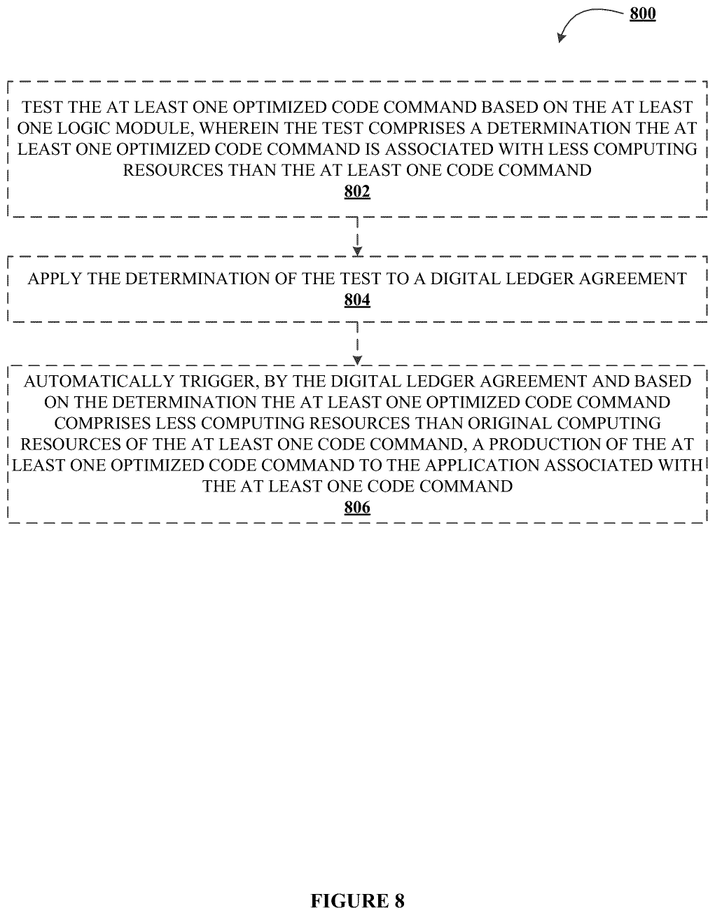

FIG. 8 illustrates a process flow 800 for automatically triggering a production of the optimized code command(s) to the application associated with the code command, in accordance with an embodiment of the disclosure. In some embodiments, a system (e.g., similar to one or more of the systems described herein with respect to FIGS. 1A-1C) may perform one or more of the steps of process flow 800. For example, a system (e.g., the system 130 described herein with respect to FIG. 1A-1C) may perform the steps of process 800. In some embodiments, an artificial intelligence engine (e.g., such as the AI engine shown in FIG. 2) may perform some or all of the steps described in process flow 800. In some embodiments, a distributed ledger technology (e.g., the DLT shown in FIGS. 3A-3B) may be used to perform some or all of the steps described in process flow 800.

In some embodiments, and as shown in block 802, the process flow 800 may include the step of testing the at least one optimized code command based on the at least one logic module, wherein the test comprises a determination that the at least one optimized code command is associated with less computing resources than the at least one code command. For instance, and in some such embodiments, the system may test the optimized code in at least one container (or a plurality of containers) designed to mimic the system environment the optimized code command will function or perform in when produced to the associated application, and the system may collect data regarding the container's system environment's computing resources when the optimized code command is run. Further, and upon determining the container's system environment's computing resources, the system may test the optimized code command against the previous version of the code command and the previous version's computing resources. In some embodiments, and in an instance where the computing resources of the optimized code command are less than the previous code command's computing resources, then the system may determine that the optimized code command is associated with the least amount of computing resources. Additionally, and as used herein, the computing resources may comprise, but are not limited to, network resources, storage resources, application resources or services, platform resources or services, security resources, servers or processing components, and/or the like.

In some embodiments, the computing resources generated within the container(s) may be generated as a computing resource rate. Such a computing resource rate may refer to a quantifiable variable indicating the overall computing resource consumption when running the code command and/or the optimized code command. Thus, and in some such embodiments, the computing resource of the previous code command may also be determined as a computing resource rate and the optimized code command's computing resource rate may be compared to the previous code command's computing resource rate to determine whether the optimized code command should be published and used within the associated application.

In some embodiments, and as shown in block 804, the process flow 800 may include the step of applying the determination of the test to a digital ledger agreement. For example, and in some embodiments, the system may apply the determination made in block 802 to a digital ledger agreement, which may be triggered to perform the steps described hereinbelow based on an instance where the optimized code command's computing resources are less than the code command's computing resources.

As used herein, the digital ledger agreement refers to a digital contract stored on blockchain that is automatically executed when an event is triggered (such as an event where the optimized code command has been verified as using less or fewer computing resources and/or has been verified by specific users). For example, and in some additional and/or alternative embodiments, the system may request inputs from at least one specified user indicating that the optimized code command is acceptable and can be produced to the associated application. Thus, and in some such embodiments, the system may require a pre-approval by a specified user(s) before the production of the optimized code command may occur. Such a specified user(s) may be pre-determined by the client of the system, by a client of the associated application, by the manager of the system, by a manager of the associated application, and/or the like.

In some embodiments, and as shown in block 806, the process flow 800 may include the step of automatically triggering, by the digital ledger agreement and based on the determination that the at least one optimized code command comprises less computing resources than original computing resources of the at least one code command, a production of the at least one optimized code command to the application associated with the at least one code command. For instance, and in some such embodiments, the system may cause the automatic triggering—by the digital ledger agreement—the production of the optimized code command to the associated application when the digital ledger agreement's condition(s) has been met. Such conditions may comprise, but are not limited to, the optimized code command comprising fewer or less computing resources than the previous version's computing resources and/or the specified user(s) accepting the optimized code command.

As used herein, and in some such embodiments, the production of the optimized code command comprises a reading of the optimized code command by the application and writing, by the application, the optimized code command to the application's software.

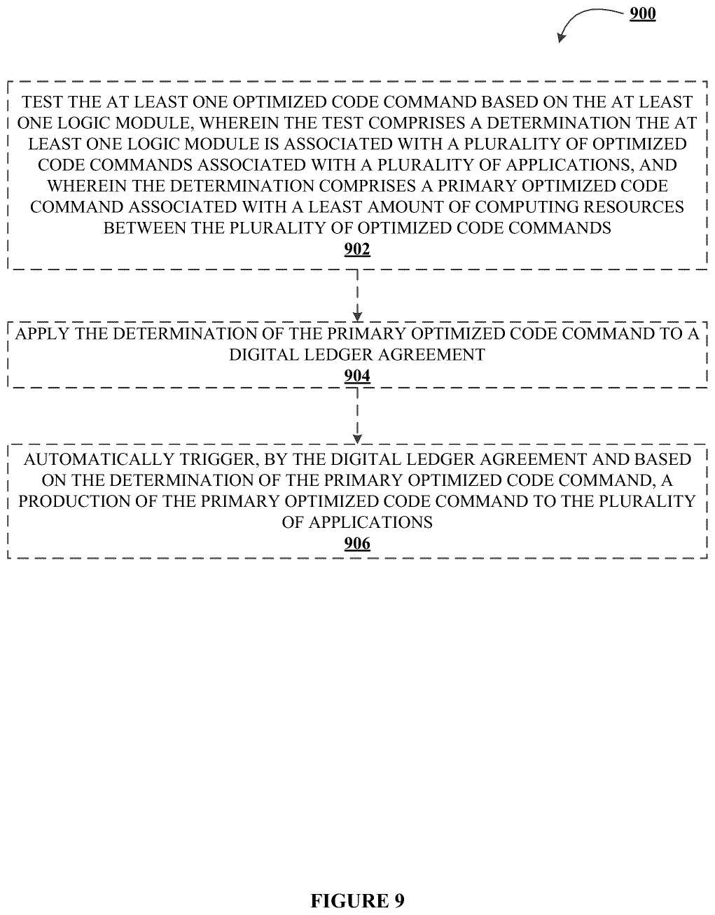

FIG. 9 illustrates a process flow 900 for automatically triggering the production of the primary optimized code command to a plurality of applications, in accordance with an embodiment of the disclosure. In some embodiments, a system (e.g., similar to one or more of the systems described herein with respect to FIGS. 1A-1C) may perform one or more of the steps of process flow 900. For example, a system (e.g., the system 130 described herein with respect to FIG. 1A-1C) may perform the steps of process 900. In some embodiments, an artificial intelligence engine (e.g., such as the AI engine shown in FIG. 2) may perform some or all of the steps described in process flow 900. In some embodiments, a distributed ledger technology (e.g., the DLT shown in FIGS. 3A-3B) may be used to perform some or all of the steps described in process flow 900.

In some embodiments, and as shown in block 902, the process flow 900 may include the step of testing the at least one optimized code command based on the at least one logic module, wherein the test comprises a determination that the at least one logic module is associated with a plurality of optimized code commands associated with a plurality of applications, and wherein the determination comprises a primary optimized code command associated with a least amount of computing resources between the plurality of optimized code commands. For example, and in some such embodiments, the system may test the optimized code command based on the logic module, where the test comprises a determination that the logic module is associated with a plurality of optimized code commands for a plurality of applications or, in other words, a shared logic module has been used for a plurality of optimized code commands across a plurality of applications. Further, and based on identifying the different optimized code commands that were based on the logic module, the system may further test the different optimized code commands to determine a primary code command that comprises the least amount of computing resources needed to run in the application. Thus, and from the potential optimized code commands associated with the logic module, the system may identify the primary optimized code command as the most optimal code command from all the potential optimized code commands. Such an optimal determination may further be based on the level or number of computing resources needed to run the potential optimized code commands, where the most optimal will use the least level or number of computing resources.

In some embodiments, and as shown in block 904, the process flow 900 may include the step of applying the determination of the primary optimized code command to a digital ledger agreement. For example, and in such embodiments, the system may apply the determination of the primary optimized code command to a digital ledger agreement (such as the same digital ledger agreement described above with respect to FIG. 8 or a different digital ledger agreement configured for this specific condition) and the digital ledger agreement may determine if the primary optimized code command should be produced to the application based on the condition(s) of the digital ledger agreement. Thus, and similar to the digital ledger agreement of FIG. 8, a condition of the digital ledger agreement may comprise but is not limited to at least one of a computing resource less than the previous code command, computing resource less than the other optimized code commands generated for the logic module, and/or the acceptance of the primary optimized code command by a specified user(s).

In some embodiments, and as shown in block 906, the process flow 900 may include the step of automatically triggering, by the digital ledger agreement and based on the determination of the primary optimized code command, a production of the primary optimized code command to the plurality of applications. Thus, and in some such embodiments, the system may cause the automatic triggering—by the digital ledger agreement—the production of the primary optimized code command to the associated application based on the condition(s) of the digital ledger agreement being met.

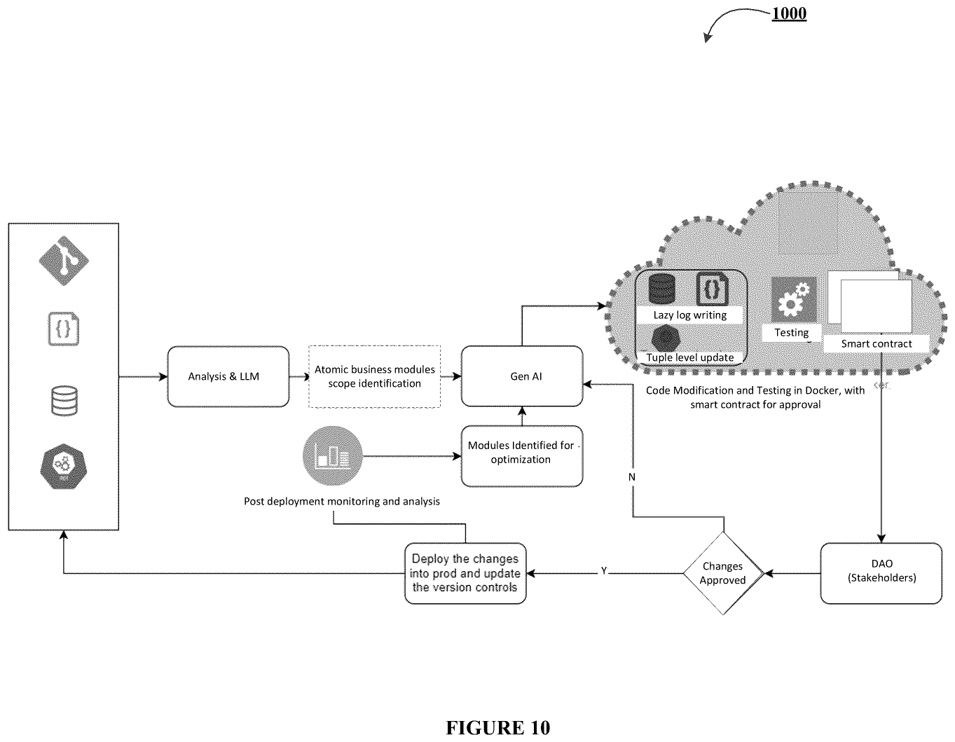

FIG. 10 illustrates a process flow diagram 1000 for tracing code changes and underlying logic for code optimization, in accordance with an embodiment of the disclosure. In some embodiments, a system (e.g., similar to one or more of the systems described herein with respect to FIGS. 1A-1C) may perform one or more of the steps of process flow diagram 1000. For example, a system (e.g., the system 130 described herein with respect to FIG. 1A-1C) may perform the steps of process flow diagram 1000. In some embodiments, an artificial intelligence engine (e.g., such as the AI engine shown in FIG. 2) may perform some or all of the steps described in process flow diagram 1000. In some embodiments, a distributed ledger technology (e.g., the DLT shown in FIGS. 3A-3B) may be used to perform some or all of the steps described in process flow diagram 1000.

As shown in diagram 1000, an overall process flow diagram for tracing code changes and underlying logic for code optimization is shown. As shown in diagram 1000, the process described herein may comprise the collection of code commands from various sources, such as from databases, data lakes, applications, files, application interfaces, and/or the like. Further, and as shown in diagram 1000, the data of each code command may be input to an LLM, which is configured to analyze the code commands and determine whether any code commands comprise any code changes. Additionally, and in some embodiments, the collection of code commands from the various sources may comprise the collection of associated data such as but not limited to input data, output data, historical logic modules, and/or the like. Once the LLM has analyzed the code commands to determine whether a code change is present, the LLM may determine a previous logic module and/or a current logic module that matches the code commands (with or without code change).

Additionally, and as shown in diagram 1000, the determination of the logic module by the LLM may be input to the generative AI engine, which may be configured to generate optimized code command(s) based on the determined logic module(s) and the previous code command(s). Additionally, and as shown in the term “lazy log writing” in diagram 1000, the generative AI engine may further be configured to generate declare messages and/or logic module messages comprising data regarding each of the code commands. In some such embodiments, the declare messages generated by the generative AI engine may be input to a log file of an associated application of the code command in batches (e.g., based on the declare message threshold and/or based on a time threshold).

Additionally, in some embodiments, the generative AI engine may be configured to determine whether the tuple variables in the output table of the code command(s) and/or the optimized code command(s) are expected or unexpected, and whether the underlying code command(s), optimized code command(s), and/or tuple variables themselves need to be revised to match the determined logic module.

Further, and in some embodiments, the generative AI engine may test the optimized code command(s) to determine whether the code command(s) meets the necessary requirements of the system (e.g., the requirements of the system, of the client of the system, of the manager of the system, and/or the like), such as but not limited to computing resource consumption, acceptable criteria by a specified user, and/or the like.

Additionally, and in some embodiments, the generated and tested optimized code command may then be input to a digital ledger agreement (or smart contract) and the digital ledger agreement may trigger a production of the optimized code command when certain conditions are met. In some embodiments, the condition of the digital ledger agreement may comprise an acceptance of the changes in the optimized code command before production to the application (which may be shown as the “DAO (stakeholders)” and “changes approved” steps). In some embodiments, and where the changes are not approved, the system may input the feedback from the specified user back to the generative AI engine for further training and generation of new optimized code commands. Alternatively, and in some instances where the changes are approved, then the system may deploy or produce the optimized code command to the application and update the version controls of the application to indicate a new version has been implemented. Further, and in some such embodiments, the system may continuously monitor and analyze the optimized code command after deployment and may repeat any of the steps herein described to continuously refine and optimize the code commands within the applications to make sure that all applications and their code commands are up-to-date and optimized.

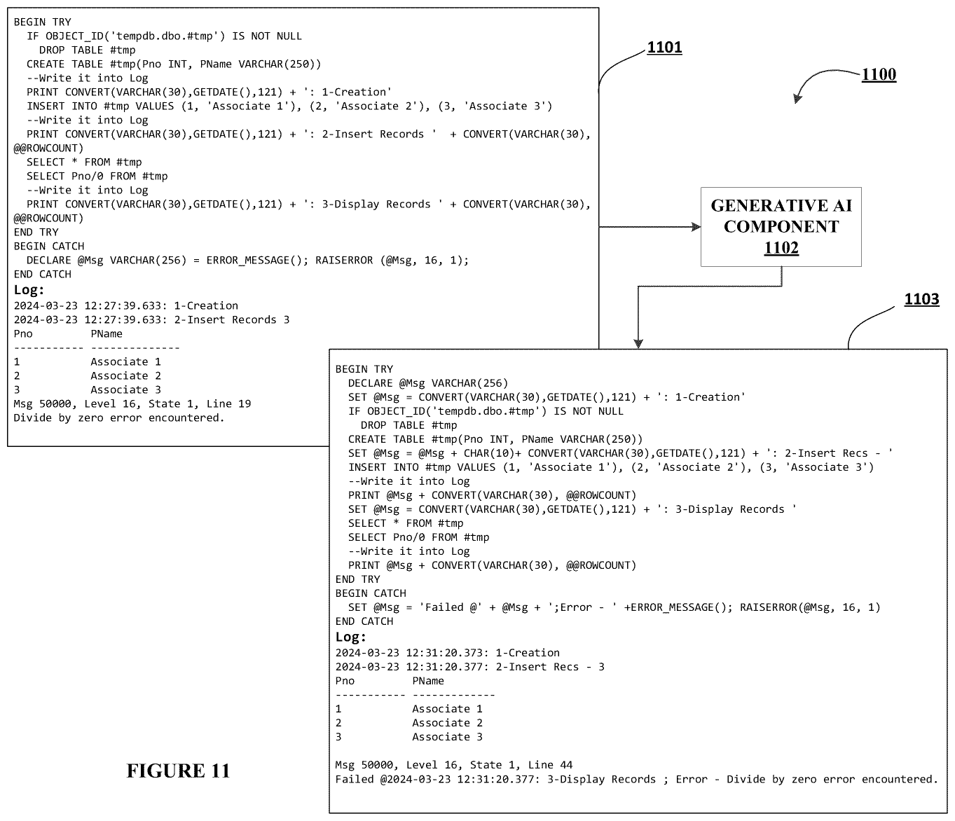

FIG. 11 illustrates exemplary code commands and declare messages examples 1100 for tracing code changes and underlying logic for code optimization, in accordance with an embodiment of the disclosure. In some embodiments, a system (e.g., similar to one or more of the systems described herein with respect to FIGS. 1A-1C) may perform one or more of the steps of generating exemplary code commands and declare messages 1100. For example, a system (e.g., the system 130 described herein with respect to FIG. 1A-1C) may perform the steps of generating exemplary code commands and declare messages 1100. In some embodiments, an artificial intelligence engine (e.g., such as the AI engine shown in FIG. 2) may perform some or all of the steps described in generating exemplary code commands and declare messages 1100. In some embodiments, a distributed ledger technology (e.g., the DLT shown in FIGS. 3A-3B) may be used to perform some or all of the steps described in generating exemplary code commands and declare messages 1100.

As shown in examples 1100, an original or previous version of code commands may be shown in box 1101, which may be input to generative AI engine or component 1102, and the generative AI engine may generate the optimized code commands shown in box 1103. As shown in box 1103, the optimized code commands may comprise various declare messages which are written into the log file (shown as “—write it into log” command) after collection of declare messages in batches. By way of non-limiting example, and as shown between boxes 1102 and 1103, the writing to the log file may be saved at least 33 percent of the time as only two commands comprising log writing are shown, as compared to the three commands of log writing shown in box 1101.

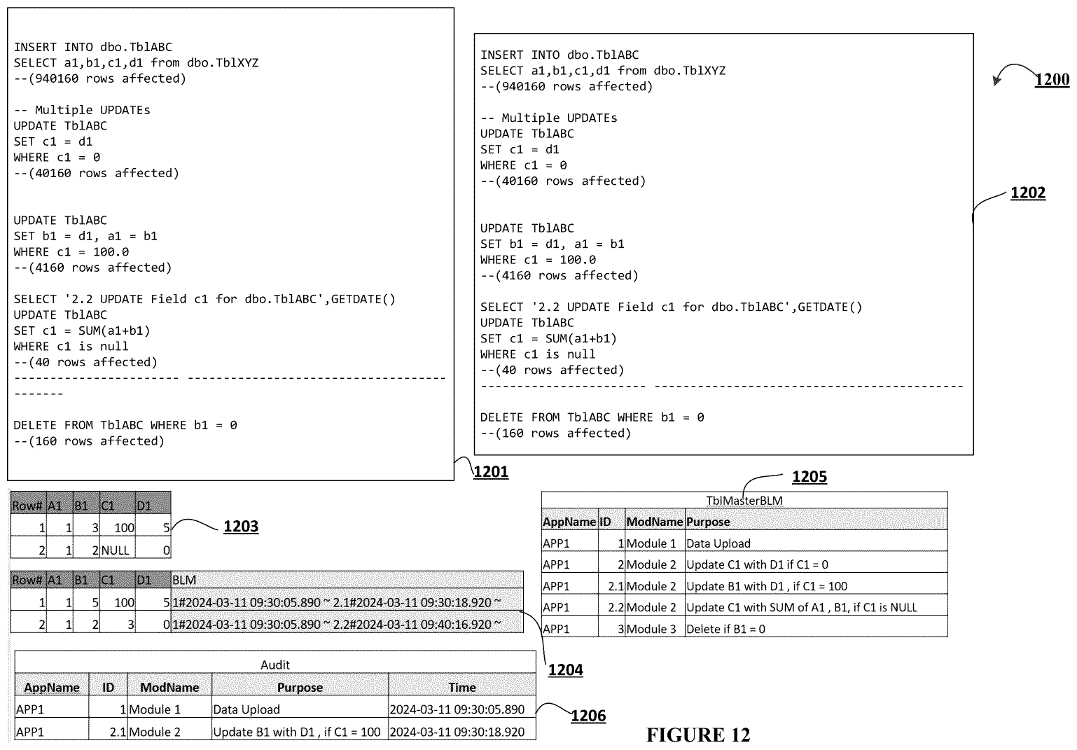

FIG. 12 illustrates exemplary code commands and optimized code commands diagram 1200 for tracing code changes and underlying logic for code optimization, in accordance with an embodiment of the disclosure. In some embodiments, a system (e.g., similar to one or more of the systems described herein with respect to FIGS. 1A-1C) may perform one or more of the steps of generating optimized code commands diagram 1200. For example, a system (e.g., the system 130 described herein with respect to FIG. 1A-1C) may perform the steps of generating optimized code commands diagram 1200. In some embodiments, an artificial intelligence engine (e.g., such as the AI engine shown in FIG. 2) may perform some or all of the steps described in generating optimized code commands 1200. In some embodiments, a distributed ledger technology (e.g., the DLT shown in FIGS. 3A-3B) may be used to perform some or all of the steps described in generating optimized code commands diagram 1200.

As shown in diagram 1200, the system may apply an input table 1203 to a code command 1201 and may receive an unexpected output tuple variable. For example, and as shown in input table 1203, which may be processed by the code command 1201, then a question may form of how the output table 1204 received 5 for B1 when C1 equaled to 500 in the input table 1203. Thus, and when faced with millions of tables similar to the output table 1204, a human user would never be able to accurately or efficiently determine all the issues and/or unexpected variables for just one tuple variable. Therefore, a system like the one disclosed herein would be needed to show the underlying logic module behind each code command (including the logic module behind a code change within the code command), a timestamp and identifier of the logic module, application, and/or the like, like that shown in output table 1204 shown in column “BLM.” Additionally, and as shown in diagram 1200, a logic module global table like that shown as table 1205 may show the purpose behind each code command, the logic module identifier, and the application identifier. Additionally, and as shown in table 1206, an audit of the actions or activities happening within the application's code commands may be generated to show which purpose has been used for each logic module and for each row within the output table.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for tracing code changes and underlying logic for code optimization, the system comprising:
a memory device with computer-readable program code stored thereon;
at least one processing device operatively coupled to the at least one memory device and the at least one communication device, wherein executing the computer-readable code is configured to cause the at least one processing device to:
identify at least one code command associated with an application;
apply a large language model (LLM) to the at least one code command;
identify, by the LLM, at least one code change in the at least one code command;
identify, by the LLM and based on the at least one code change, at least one logic module for the at least one code change;
verify, by a generative artificial intelligence (AI) engine, a link between the at least one logic module and the at least one code command comprising the at least one code change, wherein the link indicates a causation of the at least one code change with the at least one logic module; and
generate, by the generative AI engine and based on the verification of the link, at least one optimized code command based on the at least one code command and the at least one logic module.

2. The system of claim 1, wherein the at least one optimized code command comprises at least one declare message, and wherein executing the computer-readable code is further configured to cause the at least one processing device to:
transmit the at least one declare message to a log file associated with the at least one code command.

3. The system of claim 1, wherein a plurality of optimized code commands are generated by the generative AI engine, and wherein the plurality of optimized code commands comprise a plurality of declare messages, and wherein executing the computer-readable code is further configured to cause the at least one processing device to:
generate a first collection of the plurality of declare messages;
transmit the first collection of the plurality of declare messages to the log file associated with the at least one code command at a first instance; and
write, in the log file, the first collection of the plurality of declare messages at a first instance.

4. The system of claim 1, wherein executing the computer-readable code is further configured to cause the at least one processing device to:
identify at least one input table associated with the at least one code command, wherein the at least one input table comprises at least one input tuple variable;
identify at least one output table based on applying the at least one code command comprising the at least one code change to the at least one input table, wherein the at least one output table comprises an unexpected output tuple variable;
verify, by applying the at least one output table to the generative AI engine, the at least one logic module causing the at least one unexpected tuple variable; and
generate, by the generative AI engine and based on the at least one unexpected tuple variable, a logic module message comprising an application identifier and logic module identifier associated with the verified at least one logic module.

5. The system of claim 4, wherein the at least one input tuple variable and the at least one unexpected output tuple variable is associated with a same cell in the at least one input table and the at least one output table.

6. The system of claim 4, wherein the logic module message comprises a combination of the application identifier and the logic module identifier, and wherein the logic module message comprises a time stamp or date stamp of the output table.

7. The system of claim 4, wherein executing the computer-readable code is further configured to cause the at least one processing device to:
generate a logic module table, wherein the logic module table comprises each of the logic modules verified by the generative AI engine for the application associated with the at least one code command, wherein the logic module table comprises a purpose column comprising a purpose description for each logic module in the logic module table.

8. The system of claim 1, wherein executing the computer-readable code is further configured to cause the at least one processing device to:
test the at least one optimized code command based on the at least one logic module, wherein the test comprises a determination the at least one optimized code command is associated with less computing resources than the at least one code command;
apply the determination of the test to a digital ledger agreement; and
automatically trigger, by the digital ledger agreement and based on the determination the at least one optimized code commend comprises less computing resources than original computing resources of the at least one code command, a production of the at least one optimized code command to the application associated with the at least one code command.

9. The system of claim 1, wherein executing the computer-readable code is further configured to cause the at least one processing device to:
test the at least one optimized code command based on the at least one logic module, wherein the test comprises a determination the at least one at least one logic module is associated with a plurality of optimized code commands associated with a plurality of applications, and wherein the determination comprises a primary optimized code command associated with a least amount of computing resources between the plurality of optimized code commands;
apply the determination of the primary optimized code command to a digital ledger agreement; and
automatically trigger, by the digital ledger agreement and based on the determination of the primary optimized code command, a production of the primary optimized code command to the plurality of applications.

10. A computer program product for tracing code changes and underlying logic for code optimization, the computer program product comprising a non-transitory computer-readable medium comprising code causing an apparatus to:
identify at least one code command associated with an application;
apply a large language model (LLM) to the at least one code command;
identify, by the LLM, at least one code change in the at least one code command;
identify, by the LLM and based on the at least one code change, at least one logic module for the at least one code change;
verify, by a generative artificial intelligence (AI) engine, a link between the at least one logic module and the at least one code command comprising the at least one code change, wherein the link indicates a causation of the at least one code change with the at least one logic module; and
generate, by the generative AI engine and based on the verification of the link, at least one optimized code command based on the at least one code command and the at least one logic module.

11. The computer program product of claim 10, wherein the at least one optimized code command comprises at least one declare message, and wherein the computer program product further comprises non-transitory computer-readable medium comprising code causing the apparatus to:
transmit the at least one declare message to a log file associated with the at least one code command.

12. The computer program product of claim 11, wherein a plurality of optimized code commands are generated by the generative AI engine, and wherein the plurality of optimized code commands comprise a plurality of declare messages, and wherein the computer program product further comprises non-transitory computer-readable medium comprising code causing the apparatus to:
generate a first collection of the plurality of declare messages;
transmit the first collection of the plurality of declare messages to the log file associated with the at least one code command at a first instance; and
write, in the log file, the first collection of the plurality of declare messages at a first instance.

13. The computer program product of claim 11, wherein the computer program product further comprises non-transitory computer-readable medium comprising code causing the apparatus to:
identify at least one input table associated with the at least one code command, wherein the at least one input table comprises at least one input tuple variable;
identify at least one output table based on applying the at least one code command comprising the at least one code change to the at least one input table, wherein the at least one output table comprises an unexpected output tuple variable;
verify, by applying the at least one output table to the generative AI engine, the at least one logic module causing the at least one unexpected tuple variable; and
generate, by the generative AI engine and based on the at least one unexpected tuple variable, a logic module message comprising an application identifier and logic module identifier associated with the verified at least one logic module.

14. The computer program product of claim 13, wherein the computer program product further comprises non-transitory computer-readable medium comprising code causing the apparatus to:
generate a logic module table, wherein the logic module table comprises each of the logic modules verified by the generative AI engine for the application associated with the at least one code command, wherein the logic module table comprises a purpose column comprising a purpose description for each logic module in the logic module table.

15. A computer implemented method for tracing code changes and underlying logic for code optimization, the computer implemented method comprising:
identifying at least one code command associated with an application;
applying a large language model (LLM) to the at least one code command;
identifying, by the LLM, at least one code change in the at least one code command;
identifying, by the LLM and based on the at least one code change, at least one logic module for the at least one code change;
verifying, by a generative artificial intelligence (AI) engine, a link between the at least one logic module and the at least one code command comprising the at least one code change, wherein the link indicates a causation of the at least one code change with the at least one logic module; and
generating, by the generative AI engine and based on the verification of the link, at least one optimized code command based on the at least one code command and the at least one logic module.

16. The computer implemented method of claim 15, wherein the at least one optimized code command comprises at least one declare message, and further comprising:
transmitting the at least one declare message to a log file associated with the at least one code command.

17. The computer implemented method of claim 16, wherein a plurality of optimized code commands are generated by the generative AI engine and the plurality of optimized code commands comprise a plurality of declare messages, and further comprising:
generating a first collection of the plurality of declare messages;
transmitting the first collection of the plurality of declare messages to the log file associated with the at least one code command at a first instance; and
writing, in the log file, the first collection of the plurality of declare messages at a first instance.

18. The computer implemented method of claim 16, further comprising:
identifying at least one input table associated with the at least one code command, wherein the at least one input table comprises at least one input tuple variable;
identifying at least one output table based on applying the at least one code command comprising the at least one code change to the at least one input table, wherein the at least one output table comprises an unexpected output tuple variable;
verifying, by applying the at least one output table to the generative AI engine, the at least one logic module causing the at least one unexpected tuple variable; and
generating, by the generative AI engine and based on the at least one unexpected tuple variable, a logic module message comprising an application identifier and logic module identifier associated with the verified at least one logic module.

19. The computer implemented method of claim 16, further comprising:
generating a logic module table, wherein the logic module table comprises each of the logic modules verified by the generative AI engine for the application associated with the at least one code command, wherein the logic module table comprises a purpose column comprising a purpose description for each logic module in the logic module table.

20. The computer implemented method of claim 15, further comprising:
testing the at least one optimized code command based on the at least one logic module, wherein the test comprises a determination the at least one optimized code command is associated with less computing resources than the at least one code command;
applying the determination of the test to a digital ledger agreement; and
automatically triggering, by the digital ledger agreement and based on the determination the at least one optimized code commend comprises less computing resources than original computing resources of the at least one code command, a production of the at least one optimized code command to the application associated with the at least one code command.
